(19) United States
(12) Patent Application Publication
(10) Pub. No.: US 2026/0099692 A1
(43) Pub. Date: Apr. 9, 2026

(54) CARD-TYPE DATA CARRIER AND METHOD FOR MANUFACTURE THEREOF

(71) Applicant: GIESECKE+DEVRIENT EPAYMENTS GMBH, Munchen (DE)

(72) Inventors: Klaus KOHL, Miesbach (DE); Thomas TARANTINO, Laufen (DE)

(21) Appl. No.: 19/114,934

(22) PCT Filed: Oct. 10, 2023
(86) PCT No.: PCT/DE2023/100752

§ 371 Date: Mar. 25, 2025

(30) Foreign Application Priority Data
Oct. 12, 2022 (DE) 10 2022 003 763.7

(51) Int. Cl. G06K 19/077

(52) U.S. Cl. CPC G06K 19/07722

(57) ABSTRACT

A method for manufacturing a card-type data carrier has a top side and a bottom side arranged parallel to one another, and a circumferential side face that connects the top side and bottom side to one another. The side face is provided with a coloured coating in such a way that the coloured coating is spaced apart from the top side and from the bottom side along the entire circumferential side face.

The invention relates in general to the field of card-type data carriers, in particular smart cards and chip cards, for example credit and debit cards.

Card-type data carriers are frequently used in daily life, in particular as smart cards, for example magnetic strip cards, in which the data are stored on a magnetic strip, and chip cards, which are equipped with an electronic chip for storing the data and which moreover commonly likewise have a magnetic strip. Such cards have a top side, a bottom side arranged parallel thereto and a circumferential side face which connects the top side and bottom side to one another. The manufacture of such cards is varied and well known. In particular, there are cards with a single-layer or multi-layer structure, cards with a chip module embedded therein—with the inclusion of an antenna in the case of Dual Interface Chip Cards—and/or cards with a magnetic strip bonded to one side. The dimensions of such cards are standardized. The most common format is the so-called ID-1 format, for instance of credit and debit cards. These kinds of card-type data carrier, in particular, are developed by the present invention, but it is equally possible to apply the invention to cards with other formats, in particular smaller ID-formats.

Whilst most cards are produced from conventional plastic materials, there is an increasing interest in individualizing the cards in various ways. One trend, for example, involves manufacturing at least one card core layer from a special-colored plastic so that the card is easily identifiable due to its special-colored circumferential side face. This may serve, on the one hand, as an additional authenticity feature and, on the other, for individualization so as to be able to easily associate corresponding cards with a specific financial institution.

However, manufacturing the cards with respective correspondingly colored core layers presents a logistical problem. In particular, the financial institution for which the cards are intended must already be known early on in the manufacturing process and then the number of cards to be manufactured must also be already determined. This rules out production for “stockpiling”.

In this respect, it is also known to print the circumferential side face of the cards in a respective color. The individualization of the cards may then take place in a downstream production step. However, this poses the risk of the print color running onto the top side and bottom side of the card.

Therefore, an objective is to enable the individualization of cards with the lowest possible manufacturing costs using colored card side faces.

A method for manufacturing a card-type data carrier with a colored edge according to a first aspect of the present disclosure provides for the circumferential side face of the card-type data carrier to be provided with a colored coating in such a way that the colored coating is spaced apart both from the top side and from the bottom side along the entire circumferential edge.

Since the side face is not color-coated over its whole area, in particular not to the point where it adjoins the top and bottom side, this reduces the risk of the coating running around the edge of the card and onto the top and/or bottom side of the card, for instance due to capillary forces. The coating preferably extends continuously along the circumferential side face around the top and bottom side. However, it is also possible for the colored coating to have “zero” width in parts along the circumferential side face or to even be omitted in certain points or sections.

A spray method, in particular an inkjet printing method, may serve to generate the coating. Other coating techniques are likewise possible.

The coating should be as thin as possible in order to minimize the risk of it running. After drying, a suitable coating thickness is in the range between 1 and 50 μm.

The card-type data carrier is preferably aligned vertically for the coating step. Any gravity-induced running of the applied coating before it has completely dried then takes place along the side faces at most, and not in the direction of the top side or bottom side of the card-type data carrier. This further reduces the risk of the material of the coating running around the edge of the card and onto the top or bottom side.

The card-type data carrier is preferably held between two half shells during the coating step, wherein the half shells partially cover the circumferential side face in each case along the entire circumferential side face. The half shells here leave a gap through which the side face may be partially coated, in particular printed.

It is advantageous if, during the coating step, the half shells are spaced apart from the top side and the bottom side of the card-type data carrier, preferably along the entire circumferential side face. As a result, the applied coating cannot be pulled around the edge and onto the top and/or bottom side of the card due to capillary forces. It is, however, sufficient if this spacing is only provided in the region adjoining the circumferential side face. This means that the half shells may contact the top and bottom side of the card by all means at points which are remote from the circumferential side face. This is even advantageous, namely for positioning the card precisely in the half shell or between the half shells.

In particular, during the coating step, contact between the half shells and the card-type data carrier may be provided directly along the edges of the card, possibly even only there and/or possibly also only in certain sections. This means that the circumferential side face forms a respective circumferential edge with the top side of the card-type data carrier on the one hand and with the bottom side thereof on the other and the half shells each adjoin the circumferential side face at least along one of the circumferential edges during the coating step.

According to a variant of the invention, the half shells are advantageously omitted and the card-type data carrier is fixed in a holder in such a way that it is arranged relative to a coating device, for instance a print head or a print nozzle, which coats the circumferential side face according to the invention. The relative arrangement of the card-type data carrier with respect to the coating device, as facilitated by the holder, is provided in such a way that the colored coating is spaced apart both from the top side and from the bottom side along the entire circumferential edge. The advantage of this embodiment variant consists in that the half shells may be omitted since, due to the relative arrangement, the coating may take place in so precise a manner that the purpose according to the invention is achieved. In the simplest case, the colored coating is applied to the circumferential side face with a constant spacing from the top side and from the bottom side, so that it forms a circumferential strip with a constant width and a preferably uniform spacing from the top side and from the bottom side. The individualization of the cards may then be realized solely on the basis of the selected color for the coating and possibly additionally via the width of the strip.

However, the proposed method also enables additional types of individualization. In this regard, the colored coating may also be applied to the circumferential side face of the card-type data carrier with a varying spacing from the top side or from the bottom side or both from the top side and from the bottom side. To this end, the half shells simply need to be formed with a correspondingly shaped edge or the holder may be arranged in a correspondingly precise manner with respect to the coating device. This introduces numerous variation possibilities, so that each financial institution may use a circumferential strip with an individual contour, for example. The varying spacing from the top side and/or from the bottom side may therefore comprise, for example, a wave-like progression, a zigzag-like progression, a step-like progression, a crenelated progression or a progression formed in the manner of mutually adjacent curves.

The varying spacing of the colored coating both from the top side and from the bottom side preferably progresses in a similar manner; for example a zigzag-like manner in each case. In this way, a memorable pattern can form. This is true, in particular, if the varying spacing from the top side and the varying spacing from the bottom side vary uniformly along the circumferential side face, i.e. if, staying with the zigzag-like example, the intervals between the peaks and troughs of the two zigzag lines correspond to one another.

One variant provides for the varying spacing of the colored coating from the top side to be at its maximum where the varying spacing of the colored coating from the bottom side is at its minimum. With a similar progression of the varying spacing both from the top side and from the bottom side, for example in the manner of a zigzag line, and a uniform progression of both varying spacings, for example in the form of zigzag lines with corresponding intervals between the peaks and troughs of the two zigzag lines, it may be achieved that the colored coating has a strip with a constant width along the circumferential side face, for example a strip with a zigzag-like progression. In other variants, however, the strip is designed with a constant width with a wave-like or other appropriate form.

Other variants, however, provide for the varying spacing of the colored coating from the top side:
to be at its minimum where the spacing of the colored coating from the bottom side is at its minimum, or
to be at its maximum where the spacing of the colored coating from the bottom side is at its maximum, or
to be at its minimum where the spacing of the colored coating from the bottom side is at its minimum and to be at its maximum where the spacing of the colored coating from the bottom side is at its maximum.

In particular, the latter variant is particularly memorable if the progression of the varying spacing both from the top side and from the bottom side is again similar on the one hand, for example again in the manner of a zigzag line, and again uniform on the other, for example again in the form of zigzag lines with corresponding intervals between the peaks and troughs of the two zigzag lines. Consequently, it may thus be achieved that the colored coating has wide and narrow points arranged regularly along the circumferential side face.

A correspondingly manufactured card-type data carrier, for example a smart card or chip card, accordingly has a top side and a bottom side arranged parallel thereto and a circumferential side face connecting the top side and bottom side to one another, wherein a colored coating with a thickness in a range between 1 and 50 μm is provided on the circumferential side face, which colored coating is spaced apart both from the top side and from the bottom side along the entire side face and therefore does not reach as far as the top side and bottom side at any point.

Further advantages, features and details are revealed in the description below of preferred embodiments and with reference to the drawing, in which:

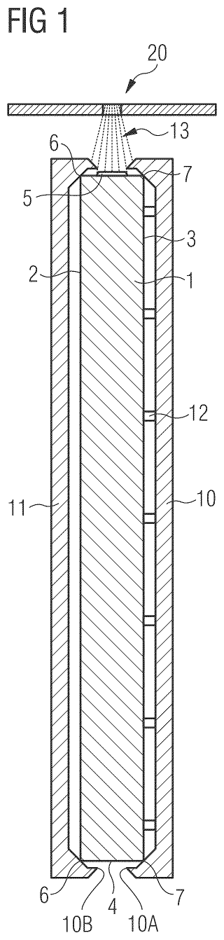

FIG. 1A shows a vertically held card-type data carrier in a schematic cross-sectional view during the coating of its side face with a colored strip,

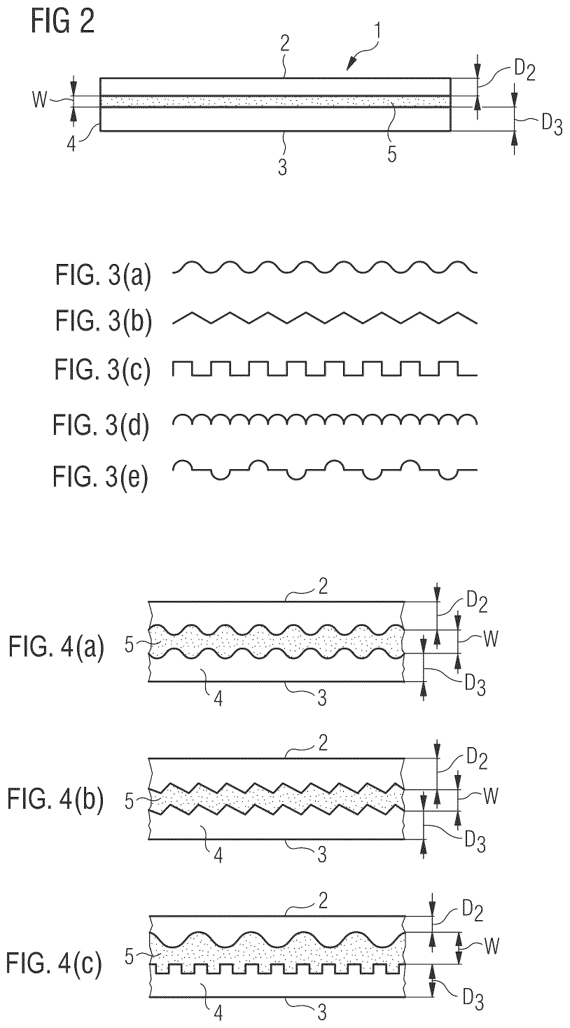

FIG. 2 shows a side view of the card-type data carrier according to FIG. 1 with a finished coating,

FIG. 3a to 3e show different edge contours of the strip according to FIG. 2,

FIG. 4a to 4c show specific exemplary embodiments for a strip according to FIG. 2.

FIG. 1 shows a card-type data carrier 1, for example a smart card or chip card or another type of card in ID-1 format or in another format (referred to simply as “card” below) during the coating of its side face 4. The card 1 is illustrated in cross section in FIG. 1 and has a top side 2, a bottom side 3 and a side face 4 connecting the top side 2 to the bottom side 3, which side face extends completely around the card 1. The top and bottom side extend parallel to one another. The card 1 therefore has a constant thickness. The circumferential side face 4 forms a circumferential edge 6 with the top side 2 on the one hand, and a circumferential edge 7 with the bottom side 3. A colored coating 5 is applied to the side face 4 using a suitable coating device 20 (illustrated merely schematically in FIG. 1), for example using an inkjet printing method. The card 1 is preferably held vertically during the coating procedure in order to ensure that the coating material does not run onto the top side 2 or bottom side 3 as a result of gravity.

To this end, the card 1 is clamped in a suitable device, which, in the illustrated exemplary embodiment, comprises two half shells 10 and 11, which cover and laterally encompass the top side 2 or bottom side 3 of the card 1. The half shells 10 and 11 may be open in part or possibly over the whole area in the region of the top side 2 and bottom side 3. What is important is that the part of the half shells 10, 11 which encompasses the side face 4 partially covers the side face 4, namely in such a way that the coating of the side face 4 is only possible in a sub-region via a gap formed between the two half shells 10, 11, which sub-region is spaced apart both from the top side 2 and from the bottom side 3, i.e. spaced apart from the circumferential edges 6 and 7. In this way, it is ensured that the coating does not run onto the top side 2 or bottom side 3.

The holder is specially designed to minimize possible capillary-force influences which could cause the coating material to run undesirably onto the top and/or bottom side of card 1. On the one hand, the half shells are spaced apart from the top side and the bottom side of the card 1; in any case, at least in a region directly adjoining the circumferential side face 4. This does not rule out contact between the half shells 10, 11 and the edges 6, 7 of the card, as shown in FIG. 1. This means that, during the coating of the circumferential side face 4, the half shells may each abut against the circumferential side face 4 (at least) along one of the circumferential edges 6, 7. On the other hand, the half shells 10, 11 are preferably in contact only with the circumferential edges 6, 7 in the region of the circumferential side face 4. This means that the part of the half shells 10, 11 which covers the side face 4 is preferably spaced far enough apart from the side face 4 to prevent the coating material from being pulled into the gap between the side face 4 and the part of the half shells 10, 11 which covers the side face 4 due to possible capillary forces in each case, as shown in FIG. 1. Accordingly, the half shells 10, 11 possess a circumferentially inclined face against which the card 1, if need be (but not necessarily), abuts with its edges 6, 7, and a part covering the side face 4, which prevents the coating material from being applied to the regions of the side face 4 which are underneath it during the coating procedure. The terminating edges 10A, 10B of these parts of the half shells 10, 11 which cover the side face 4 instead define a gap 13 through which the coating of the side face 4 takes place.

At least one of the half shells 10 may have regularly or irregularly distributed support elements 12 on which the card 1 may be placed. The height of these support elements 12 is preferably matched to the other dimensions of the half shell 10 so that the card 1, when abutting against the support elements 12, also abuts-ideally entirely-against the half shell 10 with its edge 7 or, if need be, is spaced slightly apart from this half shell. The card 1 may then be placed on the support elements 12 of the half shell 10 and covered and clamped by the second half shell 11, formed equivalently thereto, before the half shell 10 and the half shell 11, with the card 1 lying between them, are brought into the vertical position illustrated in FIG. 1. The second half shell 11 may have likewise corresponding support elements 12, although this is not compulsory.

An alternative embodiment variant illustrated in the figures provides for the card-type data carrier to be provided in a holder, which is fixed relative to a coating device which color-coats the circumferential side face in such a way that the colored coating is spaced apart from the top side and from the bottom side along the entire circumferential side face. The coating device here is a suitable print head, a print nozzle or the like, which, when suitably arranged relative to the holder, prints sufficiently precisely to apply the colored coating to the circumferential side face of the card-type data carrier in a manner according to the invention.

FIG. 2 shows the card 1 with a finished coating. In this exemplary embodiment, the coating 5 forms a strip with a constant spacing D2 from the top side 2 and a constant spacing D3 from the bottom side 3. Accordingly, the coating 5 has a constant width W along the entire circumferential side face 4.

However, the spacing D2 from the top side 2 and/or the spacing D3 from the bottom side 3 does not have to be constant; it may also vary along the circumferential side face 4. FIG. 3a to 3e show, by way of example, different possibilities for contouring the strip towards the top side 2 and/or towards the bottom side 3, namely in a wave-like, zigzag-like or crenelated manner or in the manner of mutually adjacent curves (FIG. 3a to FIG. 3d), wherein the curves do not have to directly adjoin one another but may also be spaced apart from one another (FIG. 3e).

These contours can be combined with one another and with other contours, also with a linear edge, in any desired manner. In this respect, FIGS. 4a and 4b show similar progressions of the spacing D2 from the top side 2 and the spacing D3 from the bottom side 3, namely wave-like progressions on the one hand and zigzag-like progressions on the other. In the exemplary embodiments shown according to FIG. 4a and FIG. 4b, the two respective progressions not only vary uniformly along the circumferential side face, but they also have the same interval between their wave troughs. In FIG. 4a, the peaks and troughs are arranged with respect to one another such that the width W of the resultant strip of the colored coating 5 is alternately maximal and minimal, whereas, in the exemplary embodiment illustrated in FIG. 4b, the waves and troughs are arranged such that the width W of the strip formed by the colored coating 5 is constant along the circumferential side face 4. In contrast, FIG. 4c shows an exemplary embodiment in which the two progressions of the spacings D2 and D3 vary uniformly along the circumferential side face 4 in each case. However, the progressions are dissimilar, namely wave-like with reference to the spacing D2 and crenelated with reference to the spacing D3, and have different intervals.

1.-15. (canceled)

16. A method for manufacturing a card-type data carrier having a top side and a bottom side arranged parallel to one another, and having a circumferential side face which connects the top side and bottom side to one another, characterized by the step of coating the circumferential side face with a colored coating in such a way that the colored coating is spaced apart from the top side and from the bottom side along the entire circumferential side face.

17. The method according to claim 16, wherein an inkjet printing method is used to generate the coating.

18. The method according to claim 16, wherein the card-type data carrier is aligned vertically during the coating step.

19. The method according to claim 16, wherein the card-type data carrier is held between two half shells during the coating step, wherein the half shells partially cover the circumferential side face in each case along the entire circumferential side face.

20. The method according to claim 19, wherein, during the coating step, the half shells are spaced apart from the top side and the bottom side of the card-type data carrier in a region adjoining the circumferential side face, which extends along the entire circumferential side face.

21. The method according to claim 18, wherein the circumferential side face forms a respective circumferential edge with the top side of the card-type data carrier on the one hand and with the bottom side thereof on the other and the half shells each adjoin the circumferential side face at least along one of the circumferential edges during the coating step.

22. The method according to claim 16, wherein the card-type data carrier is fixed in a holder relative to a coating device, which color-coats the circumferential side face, in such a way that the colored coating is spaced apart from the top side and from the bottom side along the entire circumferential side face.

23. The method according to claim 16, wherein the colored coating is applied to the circumferential side face with a constant spacing from the top side and from the bottom side.

24. The method according to claim 16, wherein the colored coating is applied to the circumferential side face with a varying spacing from the top side or from the bottom side or both from the top side and from the bottom side, wherein the varying spacing preferably comprises a wave-like progression, a zigzag-like progression, a crenelated progression or a progression formed in the manner of mutually adjacent curves.

25. The method according to claim 24, wherein the varying spacing both from the top side and from the bottom side progresses in a similar manner.

26. The method according to claim 24, wherein the varying spacing varies uniformly along the circumferential side face.

27. The method according to claim 24, wherein the varying spacing from the top side is at its maximum where the varying spacing from the bottom side is at its minimum.

28. The method according to claim 16, wherein the colored coating has a constant width along the circumferential side face.

29. The method according to claim 24, wherein the varying spacing from the top side
is at its minimum where the varying spacing from the bottom side is at its minimum, or
is at its maximum where the varying spacing from the bottom side is at its maximum, or
is at its minimum where the varying spacing from the bottom side is at its minimum and
at its maximum where the varying spacing from the bottom side is at its maximum.

30. A card-type data carrier having a top side and a bottom side arranged parallel to one another, and having a circumferential side face which connects the top side and bottom side to one another,
wherein a colored coating with a thickness in the range of 1 bis 50 μm on the circumferential side face,
wherein the colored coating is spaced apart from the top side and from the bottom side along the entire circumferential side face.
